(19) United States
(12) Patent Application Publication
(10) Pub. No.: US 2004/0119331 A1
(43) Pub. Date: Jun. 24, 2004

(54) Electropneumatic brake control system

(75) Inventor: Andrew C. Long, Westminster, MD (US)

Correspondence Address: BARNES & THORNBURG, 750-17TH STREET NW, SUITE 900, WASHINGTON, DC, 20006, US

(73) Assignee: Knorr Brake Corporation

(21) Appl. No.: 10/323,803

(22) Filed: Dec. 20, 2002

(51) Int. Cl. B60T 13/74

(52) U.S. Cl. 303/3

(57) ABSTRACT

A brake control system for a rail vehicle, including a reservoir providing a pressure medium output and at least one electrically-controlled valve providing an output, with both outputs being received by an emergency brake transfer valve. A control signal output from the emergency brake transfer valve is received by a relay valve, which provides a brake apply or brake release signal to a brake cylinder to either apply or release the rail vehicle's brakes.

### BACKGROUND AND SUMMARY OF THE INVENTION

The present invention relates to an electropneumatic brake control system for a rail vehicle.

A prior art system includes a reservoir providing a pressure medium output and an electrically-controlled valve providing an output received by an emergency brake transfer valve. A control signal output from the emergency brake transfer valve is received by a relay valve, which provides a brake apply or brake release signal to a brake cylinder to either apply or release the rail vehicle's brakes.

The present invention provides an improvement over that system.

Other aspects, advantages and novel features of the present invention will become apparent from the following detailed description of the invention when considered in conjunction with the accompanying drawings.

### BRIEF DESCRIPTION OF THE DRAWINGS

FIG. 1 is a schematic view of a brake control system for a rail vehicle, according to the present invention.

FIG. 2 is a schematic view of an emergency brake transfer valve, according to the present invention.

### DETAILED DESCRIPTION OF THE PREFERRED EMBODIMENTS

The present invention relates to a brake control system for a rail vehicle (not shown).

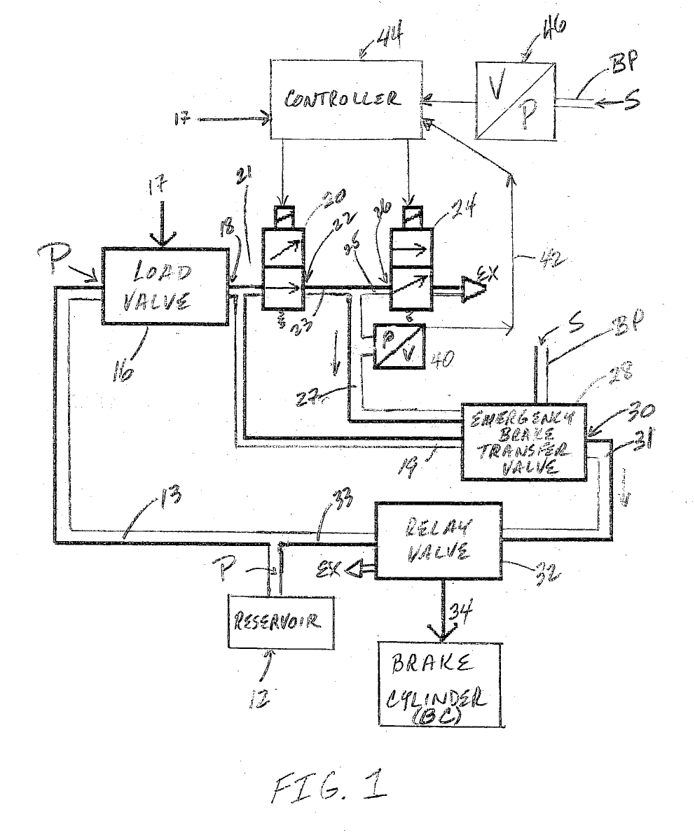

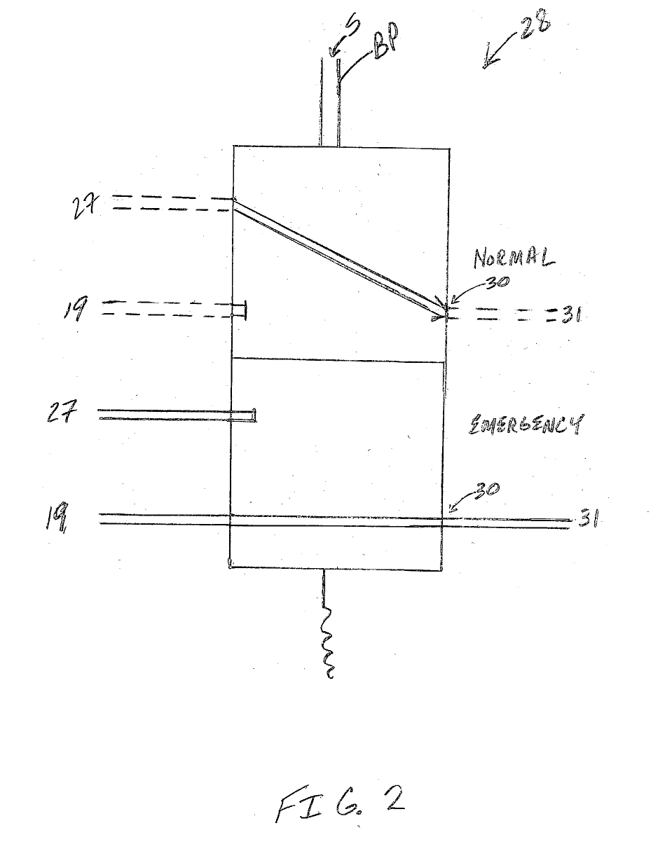

In FIGS. 1 and 2, dual connection lines represent transmission of a pressure medium or signal, such as air. A single connection line represents an electrical connection.

FIG. 1 shows a brake control system 10 that includes a reservoir 12 providing a pressure medium output P via passage 13 to load valve 16. Load valve 16 also receives a load signal 17 which may come from a rail vehicle load measuring system (not shown) and which signal 17 may be electrical (as shown) or may be a pressure medium such as air. Electrical load signals are provided to the controller as well.

Load valve 18 provides a load limited output 18 via passage 19 to emergency brake transfer valve 28. Load signal 17 determines the amount and type of load limited output 18.

The system 10 also includes an electrically-controlled apply valve 20 connected to load valve 16 and to output 18 via passage 21. Valve 20 provides an apply output 22 to emergency brake transfer valve 28 via passages 23 and 27 when valve 20 is in its opened position as shown in FIG. 1. Output 22, directing an automatic application of the rail vehicle's brakes, may occur when vehicle brake activation is selected or it may occur when valve 20 fails electrically or otherwise. System 10 also includes an electrically-controlled release valve 24. Valve 24 provides an exhaust pressure EX, or release output 26, to emergency brake transfer valve 28 via passages 25 and 27 when valve 24 is in its opened position (not shown). Such opened position directing a release of the rail vehicle's brakes, may occur when rail vehicle brake release is selected. If an electrical or other type of failure of valve 24 occurs, valve 20 fails in its closed position, as shown in FIG. 1, thereby permitting the pressure in passage 27 to pass to the emergency brake transfer valve 28.

The emergency brake transfer valve 28 also receives a pressure signal S from the rail vehicle's brake pipe BP, as shown in FIGS. 1 and 2. When rail vehicle operation is in a normal mode (non-emergency braking condition), the emergency brake transfer valve 28 is in its upper position, as shown in FIG. 2, and the pressure in passage 27 is provided as a control signal output 30. For brake application, that pressure will be apply output 22. For brake release, that pressure will be release or exhaust output 26. Or, the pressure can be whatever is locked into passage 27. When pressure signal S is an emergency braking signal, the emergency brake transfer valve 28 is in its lower position, as shown in FIG. 2, and the pressure from passage 19 is provided, via passage 31, as control signal output 30 to relay valve 32 to direct an emergency application of the rail vehicle's brakes. In emergency braking, the electrically-controlled valves 20 and 24 provide the pressure equivalent to that of output 18 to passage 27 by de-energizing valves 20 and 24 with an electronic controller 44. In other words, during normal operations, the electrically-controlled valves 20, 24 control rail vehicle braking operations via passage 27 to the emergency brake transfer valve 28, wherein control signal 30 directs an application or release of the rail vehicle's brakes. However, at least during emergency braking conditions, the emergency brake transfer valve 28 receives redundant pressures via passages 19 and 27 and uses one of those pressures to provide the control signal output 30 to direct an emergency application of the rail vehicle's brakes. Supply of essentially the same pressure at ports 19 and 27 ensures emergency brake pressure application in the event of an emergency brake transfer valve 28 failure. The pressure in passages 19 and 27 may be a portion of the value of pressure medium P depending, among other factors, upon the operating position of valves 20, 24, and vehicle load.

As mentioned above, the system 10 further includes relay valve 32 connected via passage 31 to emergency brake transfer valve 28 and control signal output 30. Relay valve 32 provides a signal 34 to brake cylinder BC. Signal 34 is one of a brake apply or brake release signal to apply or release the rail vehicle's brakes. Accordingly, during normal operations, signal 34 is at least a portion of pressure medium P coming from passage 33 to apply the brakes or it is release output 26 to release the brakes. During emergency braking conditions, signal 34 is at least a portion of pressure medium P to apply the brakes.

The system 10 may also include a valve pressure transducer 40 connected via passage 27 to the apply and release valves 20, 24 and their respective outputs 22, 26. The transducer 40 provides a feedback signal 42 to the electronic controller 44 that electronically controls the apply and release valves 20, 24 respectively. The feedback signal 42 may cause the controller 44, through valves 20, 24 to adjust the pressure in passage 27 by selectively opening and closing one or both of valves 20, 24.

The system 10 may further include a brake pipe pressure transducer 46 connected to the electronic controller 44 for controlling valves 20, 24. Transducer 46 is also connected to the brake pipe BP. In response to an emergency brake pipe pressure signal S, transducer 46 may cause a cut-off of electrical signals to the electrically controlled valves 20, 24. Upon cut off, valves 20, 24 fail as shown in FIG. 1. Release valve 24 is not vented to exhaust EX and the apply output 22 or pressure in passages 23 and 27 are provided to the emergency brake transfer valve 28.

In addition, in response to an emergency brake pipe pressure signal S, transducer 46 may cause the electrically-controlled valves 20, 24 to go to their respective opened and closed positions, as shown in FIG. 1, with the pressure in passages 23 and 27 provided to the emergency brake transfer valve 28 as just described.

The system 10 may be designed such that upon failure (such as by fire or physically breaking or equivalent event) of the electrically-controlled valves 20, 24 the apply valve 20 fails in its opened position (as shown in FIG. 1) so as to provide the apply output 22 to the emergency brake transfer valve 28 via passages 23 and 27, directing and automatic application of the rail vehicle brakes by control signal 30 via passage 31 to the relay valve 32. Correspondingly, the release valve 24 fails in its closed position (as shown in FIG. 1) so that it is not vented to atmosphere or exhaust Ex and does not permit the venting output 26 to pass to the emergency brake transfer valve 28 via passages 25 and 27.

The load valve 16 may be connected between the reservoir 12 and the apply valve 20, as shown in the embodiment of FIG. 1. The load valve 16 may also be connected between other elements of system 10, such as between the emergency brake transfer valve 28 and the relay valve 32, although none of these other possible connections are shown. Or, system 10 may be operable without the load valve 16.

When a system, such as system 10, is configured without the load valve 16, the pressure medium output P is received directly by apply valve 20 via passage 13 and the system 10 operates essentially the same as described above and shown in FIG. 1, except that the apply valve output 22 is the pressure medium P instead of a limited output 18. For example, pressure medium P is provided to the emergency brake transfer valve 28 via passage 19 and, when apply valve 20 is in its opened position as shown in FIG. 1. Pressure medium P is provided to valve 28 via passages 23 and 27. Valve 20 may be in the opened position when brake activation is selected in normal operations, or in response to an emergency brake pipe pressure signal S or upon failure of valves 20, 24.

In an embodiment having no load valve 16 (not shown) or in an embodiment having the load valve 16 connected between the emergency brake transfer valve 28 and the relay valve 32 (not shown), the control signal output 30 may be at least the pressure medium output P or one or both of the pressure medium output P and the apply output 22, which may be equal. That may occur when the emergency brake transfer valve 28 receives an emergency brake pipe pressure signal S directing an application of the rail vehicle's brakes or when the electrically-controlled valves 20, 24 fail whether or not there is an emergency brake pipe pressure signal S.

In the embodiment having the load valve 16 connected between the emergency brake transfer valve 28 and the relay valve 32, the control signal output 30 may be modified by the load valve 16. The load valve 16 may provide a load-limited output (not shown) to the relay valve 32 directing application or release of the rail vehicle's brakes

The pressure medium P supplied by the reservoir may be air or other equivalent or alternative media. The reservoir may be filled by the brake pipe BP or a main reservoir pump (not shown).

The apply and release valves 20, 24, respectively, may be individual valves, as shown in FIG. 1, or may be constructed as one valve, integrally or monolithically (not shown).

Generally, using FIGS. 1 and 2 for reference, the brake control system 10 operates as follows. The reservoir 12 provides the pressure medium P that is fed, via passage 13, to the load valve 16, which may modify the pressure medium P in response to the load signal 17 representing the load condition of the rail vehicle. The load valve 16 provides, via passage 21, load-limited output 18 to electrically-controlled apply valve 20. The output 22 of apply valve 20 and the output 26 of electrically-controlled release valve 24 are connected via passages 23 and 25 respectively, to passage 27. Release valve 24 is connected to exhaust EX. Both valves 20, 24 are also connected to and controlled by an electronic controller 44. The load-limited output 18 is connected directly to the emergency brake transfer valve 28 via passage 19.

During regular or normal train operations, with brake pipe pressure signal S at normal or non-emergency status, if vehicle braking is selected by the controller 44 or if the electrically-controlled valves 20, 24 fail electrically, then the release valve 24 fails in a closed position, and the apply valve 20 fails in an opened position, as shown in FIG. 1. Load limited output 18 is connected via passage 19, and apply output 22 is connected via passage 27, to the emergency brake transfer valve 28. Valve 28 selects one of the pressures from passages 19 and 27 to send as a control signal 30 to the relay valve 32 to apply all or a portion of the reservoir-supplied pressure medium P, from passage 33, as a braking pressure to apply the rail vehicle's brakes. The braking pressure is transmitted by signal 34 to the brake cylinder BC.

However, if the brake pipe pressure S is an emergency brake pipe pressure signal, the emergency brake transfer valve 28 will select one of the pressures from passages 19 and 27 as control signal 30. That control signal 30 will be sent to the relay valve 32 via passage 31 to direct application of the rail vehicle's brakes.

Additionally, if there is an emergency brake pipe pressure signal S, transducer 46 will send a signal to electronic controller 44 which may cause the controller 44 to select brake application by positioning apply valve 20 and release valve 24 to the positions shown in FIG. 1, such that apply output 22 is sent to the emergency brake transfer valve 28. Or, the emergency brake pipe pressure signal S may cause apply valve 20 to move to its opened position (if not already there) and cause the release valve 24 to move to its closed position (if not already there), as shown in FIG. 1, such that apply output 22 is sent to the emergency brake transfer valve 28. In either case, control signal output 30, via passage 31 to the relay valve 32, will be one or both of the pressures at passages 19 and 27, directing an application of the rail vehicle's brakes.

During regular or normal train operations, if vehicle brake release is selected, then the apply valve 20 is set to a closed position and the release valve 24 is set to an opened position (not shown). Output 26 is connected to exhaust EX and also connected to the emergency brake transfer valve 28 via passages 25 and 27. Valve 28 then sends the exhaust output 26 as control signal 30 to the relay valve 32 via passage 31, directing a release of the rail vehicle's brakes.

Although the present invention has been described and illustrated in detail, it is to be clearly understood that this is done by way of illustration and example only and is not to be taken by way of limitation. The spirit and scope of the present invention are to be limited only by the terms of the appended claims.

We claim:

1. A brake control system for a rail vehicle, comprising:
a reservoir providing a pressure medium output:
a load valve receiving the pressure medium output and providing a load-limited output;
an electrically-controlled apply valve receiving the load-limited output and providing an apply output when vehicle brake activation is selected;
an electrically-controlled release valve providing a release output when vehicle brake release is selected;
an emergency brake transfer valve, responsive to a brake pipe pressure signal, and receiving the load-limited output from the load valve and the apply or release output from one of the apply and release valves, respectively, and providing at least one of the load-limited output, apply output and release output as a control signal output; and
a relay valve receiving the control signal output from the emergency brake transfer valve and providing one of a brake apply signal and a brake release signal output to a brake cylinder to one of apply and release the rail vehicle's brakes.

2. The system of claim 1, wherein upon electrical failure of the electrically-controlled valves, the apply valve fails in an opened position to provide the apply output to the emergency brake transfer valve.

3. The system of claim 2, wherein upon electrical failure of the electrically-controlled valves, the release valve fails in a closed position to not permit the release output to pass to the emergency brake transfer valve.

4. The system of claim 1, wherein upon electrical failure of the electrically-controlled valves, the release valve fails in a closed position to not permit the release output to pass to the emergency brake transfer valve.

5. The system of claim 1, wherein upon electrical failure of the electrically-controlled valves, the emergency brake transfer valve provides one of the load-limited output and the apply output as the control signal output to the relay valve which provides a brake apply signal to the brake cylinder.

6. The system of claim 1, wherein the emergency brake transfer valve further receives an emergency brake pipe pressure signal causing the emergency brake transfer valve to provide the control signal output to the relay valve directing application of the rail vehicle's brakes in response to an emergency brake pipe pressure signal.

7. The system of claim 6, wherein the control signal output is one or both of the load-limited output and the apply output.

8. The system of claim 1, further including a valve pressure transducer connected to the apply and release outputs and providing a feedback signal to an electronic controller for controlling the apply and release valves.

9. The system of claim 1, further including a brake pipe pressure transducer connected to an electronic controller for controlling the apply valve to provide the apply output to the emergency brake transfer valve in response to an emergency brake pipe pressure signal.

10. The system of claim 1, further including a brake pipe pressure transducer connected to an electronic controller controlling and causing an electrical failure of the electrically-controlled valves in response to an emergency brake pipe pressure signal.

11. The system of claim 1, wherein the apply and release valves are one valve.

12. A brake control system for a rail vehicle, comprising:
a reservoir providing a pressure medium output:
an electrically-controlled apply valve receiving the pressure medium output and providing an apply output to automatically apply the rail vehicle's brakes when one or more of an electrical failure occurs and brake activation is selected;
an electrically-controlled release valve providing a release output when vehicle brake release is selected and, when electrical failure occurs, failing in a closed position;
an emergency brake transfer valve, responsive to a brake pipe pressure signal, and receiving the pressure medium output from the reservoir and an output from one of the apply and release valves, and providing at least one of the pressure medium output, apply output and release output as a control signal output; and
a relay valve receiving the control signal output from the emergency brake transfer valve and providing one of a brake apply signal and a brake release signal output to a brake cylinder to one of apply and release the rail vehicle's brakes.

13. The system of claim 12, including a load valve connected between the reservoir and the apply valve.

14. The system of claim 12, including a load valve connected between the emergency brake transfer valve and the relay valve.

15. The system of claim 12, wherein the emergency brake transfer valve further receives an emergency brake pipe pressure signal causing the emergency brake transfer valve to provide the control signal output to the relay valve directing application of the rail vehicle's brakes in response to an emergency brake pipe pressure signal.

16. The system of claim 15, wherein the control signal output is at least the pressure medium output.

17. The system of claim 15, wherein the control signal output is one of the pressure medium output and the apply output.

18. The system of claim 15, wherein upon electrical failure of the electrically-controlled valves, the emergency brake transfer valve provides one or both of the pressure medium output and the apply output as the control signal output to the relay valve which provides a brake apply signal to the brake cylinder.

19. The system of claim 15, further including a valve pressure transducer connected to the apply and release outputs and providing a feedback signal to an electronic controller for controlling the apply and release valves.

20. The system of claim 15, further including a brake pipe pressure transducer connected to an electronic controller for controlling the apply valve to provide an apply output to the emergency brake transfer valve in response to an emergency brake pipe pressure signal.

21. The system of claim 1, further including a brake pipe pressure transducer connected to an electronic controller causing an electrical failure of the electrically-controlled valves in response to an emergency brake pipe pressure signal.
